(19) United States
(12) Patent Application Publication
(10) Pub. No.: US 2015/0253144 A1
(43) Pub. Date: Sep. 10, 2015

(54) METHODS AND ROUTE PLANNING SYSTEMS FOR DYNAMIC TRIP MODIFICATIONS AND QUICK AND EASY ALTERNATIVE ROUTES

(71) Applicant: Sackett Solutions & Innovations LLC, Houston, TX (US)

(72) Inventors: Nemoy Rau, Houston, TX (US); Hans Rau, Fishers, IN (US); Esha Rau, Houston, TX (US)

(21) Appl. No.: 14/642,975

(22) Filed: Mar. 10, 2015

Related U.S. Application Data
(60) Provisional application No. 61/950,476, filed on Mar. 10, 2014.

(51) Int. Cl. G01C 21/34; G06Q 10/06

(52) U.S. Cl. CPC G01C 21/34; G06Q 10/067

(57) ABSTRACT

A Dynamic Personal Trip Routing System (DPTRS) which provides users with routes recommendations as a factor of weather and traffic conditions, as well as periodic and historical collected data. The DPTRS also includes a subsystem architecture which provides users the ability to contribute to data collection and update data to be used in providing real-time traffic forecasts. The DPTRS allows for the use of a unique revenue model.

### CROSS REFERENCE TO RELATED APPLICATIONS

This application claims the benefit of U.S. Provisional Application No. 61/950,476, filed Mar. 10, 2014, the contents of which are incorporated herein by reference.

### BACKGROUND OF THE INVENTION

The present invention relates to travel route planning systems and methods and applications therefor.

Automobile navigation systems and smart phone navigation applications equipped with global positioning systems (GPS) are increasingly being used by many drivers to assist in finding suitable and potentially optimal routes to new destinations and routine locations, such travel being referred to herein as a “trip” or “trips.” Once a destination is set by the driver, these applications are capable of directing a driver with turn-by-turn instructions in real-time during the course of the trip. Alternative and optimal routes are identified with the use of route planning software that may make use of a variety of features. Depending on the sophistication of the system and its software, these systems and applications (which may be referred to herein as route planning systems, or more simply as systems) may provide information on traffic conditions, and may display this information as color codes on route maps or icon notifications. The driver may use a route planning system in tandem with other applications, devices, or websites to keep apprised of current traffic conditions, weather conditions, or other factors that may adversely affect traveling. However, these other applications collect different data from a diverse array of sources and methods, with an accompanying variation in accuracy and reliability. As such, it becomes the responsibility of the driver to piece together these disparate sources to decide the best route to take.

A wealth of information is regularly collected by government departments, researchers, and observant drivers on traffic patterns and routes. However, most route planning systems do not take into account the broad range and depth of available information. While many applications such as Google® Maps, Apple® Maps, and NAVTEQ®, may be requested to take into account current traffic conditions and update a recommended route accordingly, it may not do so automatically and may not acquire the full range of available information. In addition, a wide range of research has been performed on traffic and congestion patterns which can help forecast traffic conditions before they occur as a factor of the time of the day or week, weather conditions, accidents, and construction. However, current route planning systems only take into account current conditions, and do not consider conditions in advance as they develop or may develop, especially conditions which the driver may encounter during the course of their trip.

In light of the above, route planning systems typically require the use of common sense and knowledge of local roadways on the part of the user to be used effectively and to avoid time-consuming or potentially dangerous recommendations from the routing software, such as traveling down narrow, unpaved, or potentially treacherous city streets or rural roads. As a result, there is a demand for a route planning system which provides a user with route recommendations, while providing route updates in real time and while taking into account a wide range and spectrum of available information. In addition, it would be desirable if the content of such a system could be possibly partially user-generated, such that common sense and experience of drivers can be imparted to the system as a whole. Such a system would require a defined architecture to be able to process the large amounts of data ingoing and outgoing for several hundred thousand users, as well as a feasible revenue model to support its administration.

### BRIEF DESCRIPTION OF THE INVENTION

The invention provides methods and trip route planning systems capable of providing dynamic trip modifications and alternative routes to a driver. These methods and systems, the latter hereinafter referred to as a Dynamic Personal Trip Routing System (DPTRS system), preferably provide drivers with advanced route planning, including weather and traffic congestion avoidance.

The DPTRS system integrates at least two different subsystems of information management. A first of the subsystems can operate independently of the user, and collects and maintains information on the current travel conditions on all roads and highways of a predetermined geographical area, which in some embodiments may encompass an entire nation. The first subsystem also maintains information on historical traffic patterns, as well as current information about road construction, closures, accidents, event traffic, weather and precipitation and other periodic conditions. A second of the subsystems continuously monitors the driver's position and forecasts the expected travel time on the route chosen. This system can also include user preferences (see below) or personalized weather forecasts. The DPTRS system integrates these two subsystems, with the driver's progress being constantly monitored and any necessary or optional alternative routes being provided.

Several optional additional aspects of the DPTRS system can be utilized to complement and provide greater functionality to basic trip routing framework. According to a first of these optional additional aspects, the DPTRS system may further include a subsystem adapted to integrate each driver's individual user preferences into the system as a user profile entered by a user. Such preferences may include common destinations; required or preferred time of arrival; preferred travel routes; required or preferred types of roads; avoidance of certain types of roads; preferred toll or ferry cost; avoidance of tolls; required or preferred driving durations (in total or intervals); required or preferred driving distances (e.g., per hour, day, etc.); required or preferred periodic rest intervals; preferences for time of day or day of week travel; user trip types such as business, vacation, leisure, or commute; preferred or anticipated gas or food stops or breaks; required or preferred locations for fuel, food, drink, restroom, lodging, or rest stops; points of interest; and meteorological phenomena avoidance. In addition, the subsystem may automatically compile any such user preferences for an individual user.

Another of the optional additional aspects of the DPTRS system can utilize a subsystem adapted to collect changing information such as weather conditions, road conditions, and unforeseen events such as accidents. The information can then be relayed to the user in real-time to provide alternative routing, if necessary. This subsystem would not need to be activated, but can run passively while the driver is using the DPTRS system. The information may be conveyed through a simple color-coded index system of condition intensity levels.

Yet another of the optional additional aspects of the DPTRS system can utilize a subsystem adapted to perform data collection for periodic, event specific, and historical weather and traffic information. The collected data may include data from government transportation records, as well as research and human consultants.

The invention further provides system architecture that enables the DPTRS system to be provided to several hundred thousand users simultaneously. After each trip, route information collected by the DPTRS system may be used to update one or more servers of a Dynamic Traveling Route Management (DTRM) subsystem, possibly with convenient user devices such as smartphones, tablets, vehicle infotainment systems, system-dedicated devices, etc., which further improves the ability of the DPTRS system to provide individual recommendations.

A further preferred but optional aspect of the invention is a revenue model that can be applied to the DPTRS system, which is preferably capable of providing full service to each user.

Other aspects and advantages of this invention will be better appreciated from the following detailed description.

### BRIEF DESCRIPTION OF THE DRAWINGS

FIG. 1 is a block diagram depicting an example of basic parameters and architecture for a Traffic Flow Information (TFI) subsystem suitable for use with a Dynamic Personal Trip Routing System (DPTRS system).

FIG. 2 is a block diagram depicting the TFI subsystem as adapted to update map and traffic information based on peak hours and area population density.

FIGS. 3 to 5 are block diagrams depicting how the TFI subsystem and a Dynamic Traveling Route Management (DTRM) subsystem can be adapted to interact with personal users through a user device.

FIG. 6 is a diagram depicting a network architecture representing access by contributors and users to data in the DPTRS system.

FIGS. 7 and 8 are diagrams depicting a suitable architecture for the DPTRS system and DTRM subsystem.

FIG. 9 is a flow diagram depicting a revenue model suitable for use with the DPTRS system among several different types of routing applications.

FIG. 10 is a flow diagram depicting payment methods that can be used with the revenue model of FIG. 9.

FIGS. 11, 12 and 13 are block diagrams depicting DPTRS system architectures for providing routing for short trips, combination trips, and long trips, respectively.

FIG. 14 is a block diagram depicting levels of details which a user profile may provide to the DPTRS system.

FIG. 15 is a block diagram depicting processes that may be performed by the DPTRS system to generate a route.

FIG. 16 is a block diagram depicting a plurality of sources of dynamic information that can be retrieved into and used by the DPTRS system to generate a route.

FIG. 17 is a table illustrating a Driving Conditions Tracker (DCT) correlation of weather conditions to color index.

### DETAILED DESCRIPTION OF THE INVENTION

The Dynamic Personal Trip Routing System (DPTRS) discussed below in reference to the drawings is intended to dynamically provide users with route recommendations that can take into consideration a wide variety of possible and potentially variable conditions, including but not limited to changes in traffic (e.g., congestion, accidents, event-related, etc.), roadway (e.g., construction, surface conditions, closings, etc.), and weather conditions that a user will encounter en route on their trip, as well as periodic and historical collected data relating to traffic, roadway and weather pertaining to various events and external conditions. As such, the DPTRS system is intended to take into account not only current conditions, but also conditions in advance as they develop or may develop, especially conditions which the driver may encounter during the course of a chosen route. Data relating to such conditions constitute at least part of what will be referred to herein as “relevant data” used by the DPTRS system and its components. Additionally, the DPTRS system preferably makes use of “local sense,” an approximation of user-intuited knowledge about local traffic patterns and routes. This concept will be explained in greater detail below. The DPTRS system also preferably makes use of a system architecture which provides users the ability to contribute to collection and updating of the relevant data used in providing real-time traffic forecasts. The DPTRS system can be implemented with a viable revenue model for its use. Although the invention will be described hereinafter in reference to particular functions schematically identified in the drawings, it should be noted that the teachings of the invention are not limited to these particular functions, and the invention does not require all of the functions or the interfunctionality represented in the drawings.

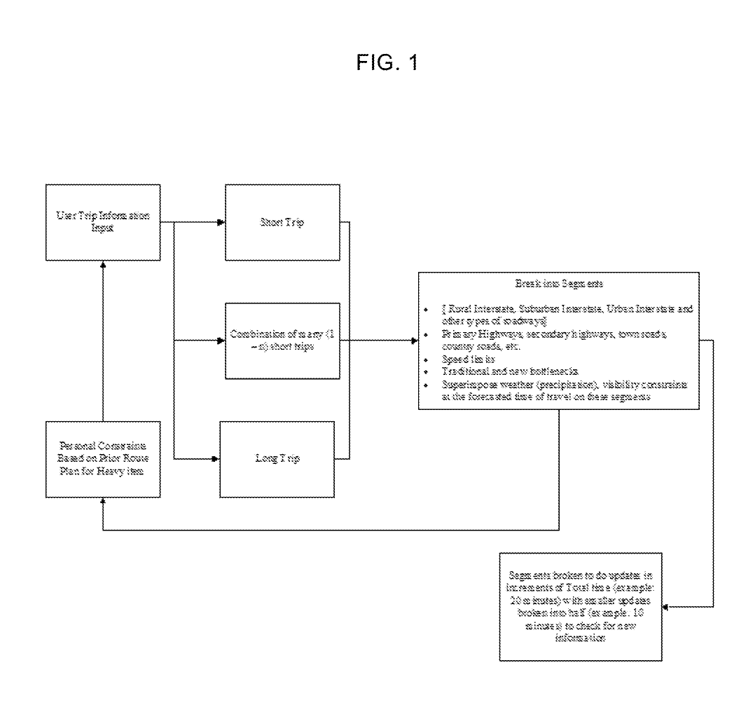

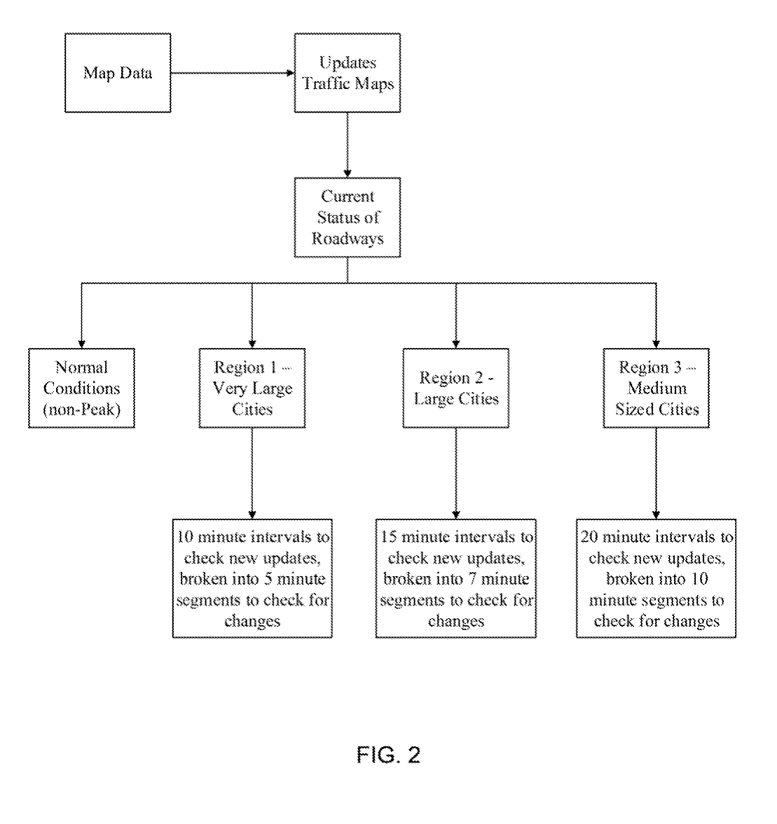

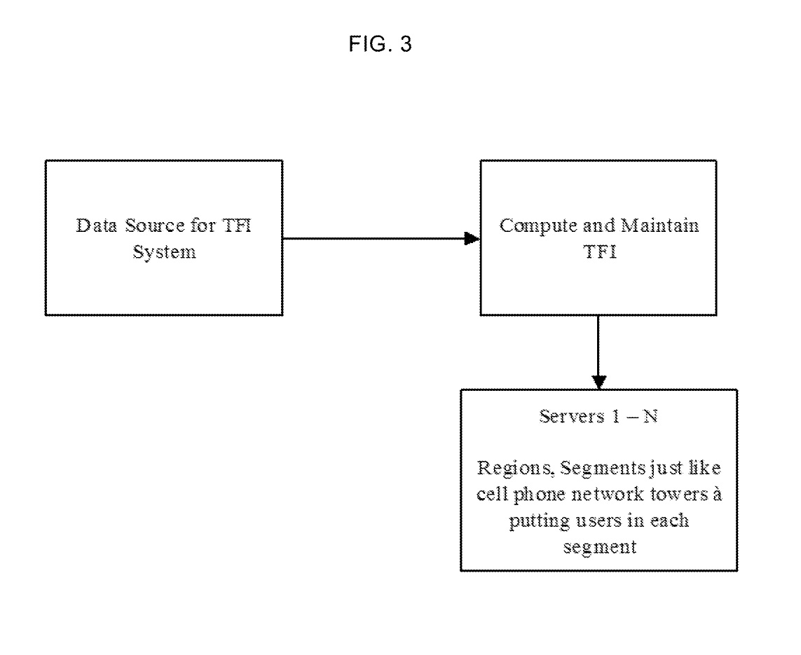

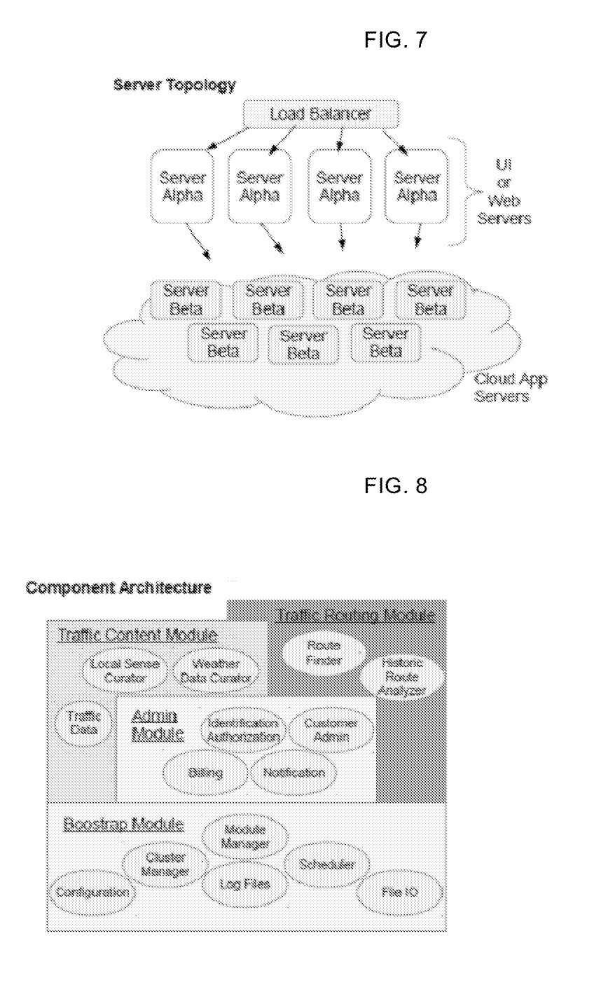

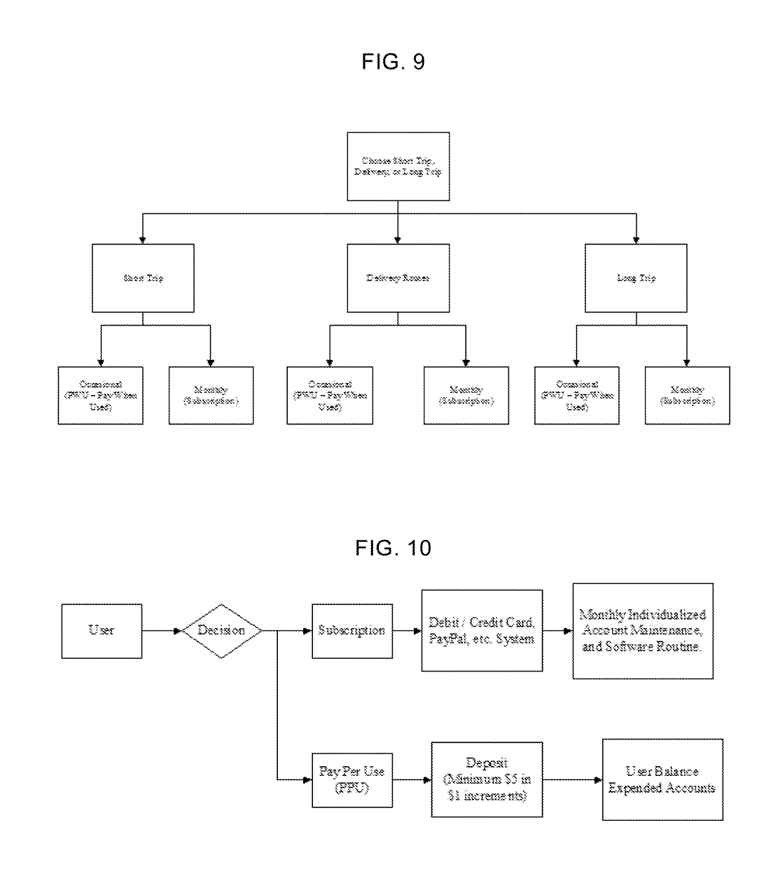

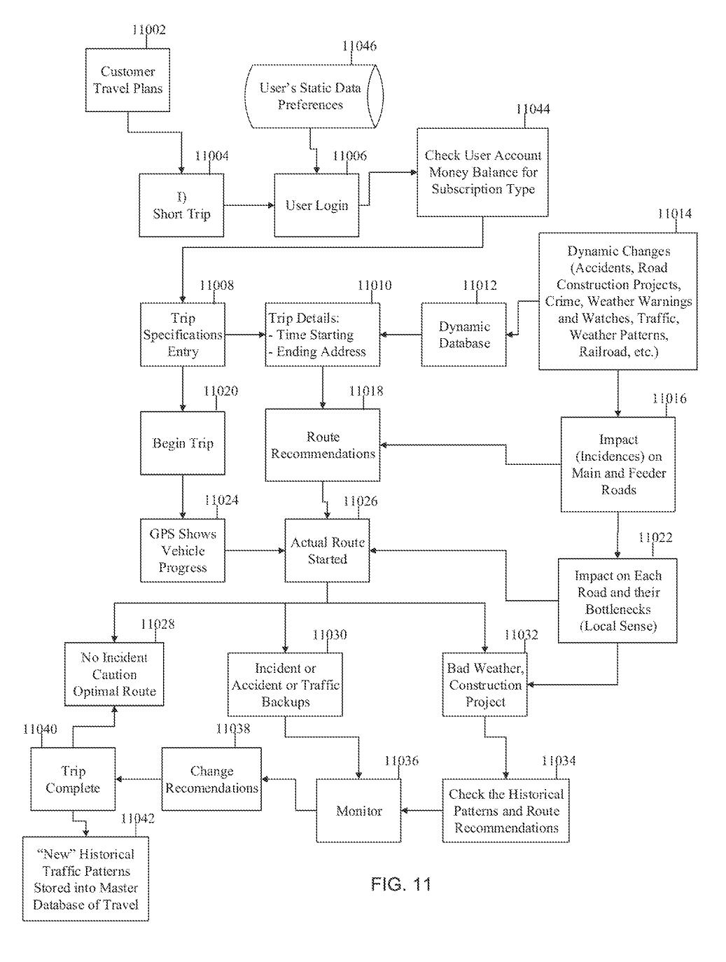

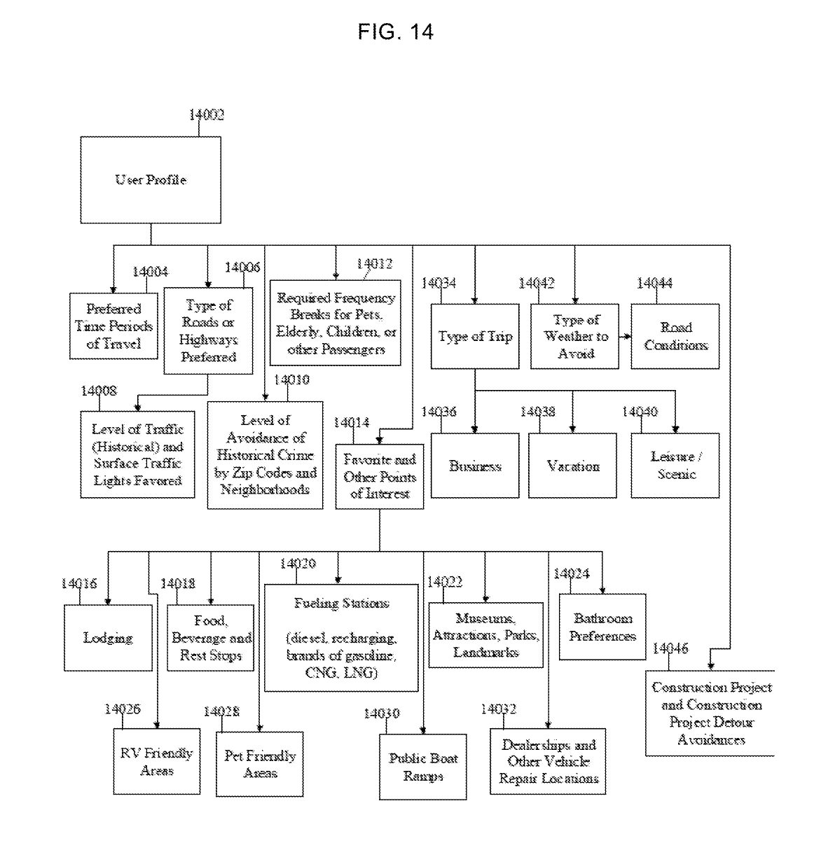

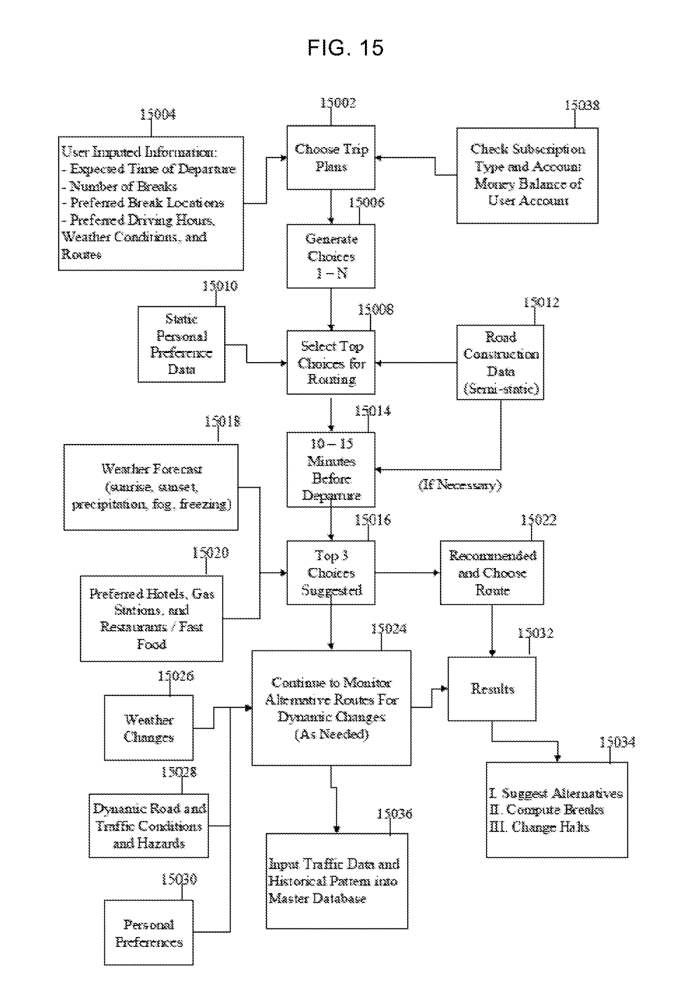

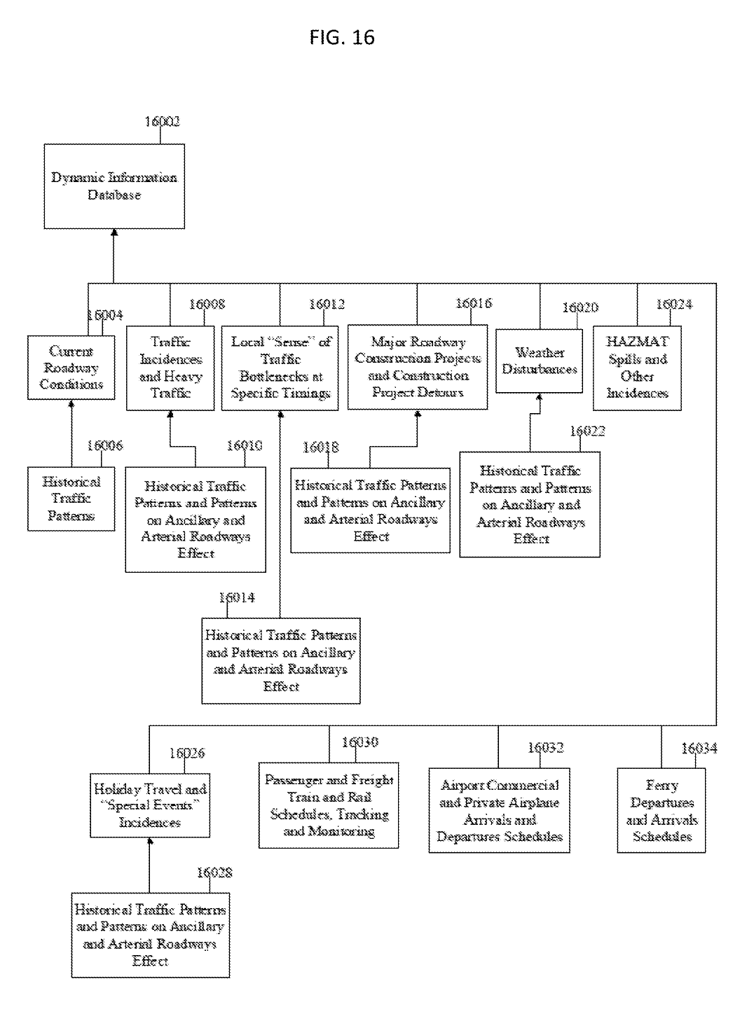

FIG. 1 is a basic overview of a component of the DPTRS system. This component, referred to herein as a Traffic Flow Information (TFI) subsystem, collects and analyzes traffic and weather information, forecasts traffic conditions, and provides route recommendations to the user. A second component of the DPTRS system is a Dynamic Traveling Route Management (DTRM) subsystem that interacts with the TFI subsystem (FIG. 3) and comprises one or more servers (FIGS. 7 and 8) for storing the relevant data for the DPTRS system. FIG. 1 indicates that the TFI subsystem makes use of trip information, which can be as simple as the target destination, that is input by the user into the DPTRS system. The TFI subsystem maintains maps (FIG. 2), and collects relevant data from a variety of sources, including a dynamic information database (FIG. 16) that may be the same as or associated with a Data Source for TFI System identified in FIG. 3. The DPTRS system can take the current location of the user as the starting point. Additionally, and as discussed in greater detail in reference to FIG. 14, the TFI subsystem can allow the user to create a user profile by inputting additional data or travel information that can be used by the TFI, nonlimiting examples of which may include desired travel time, rest intervals, desired points of interest, restaurants, landmarks, duration, preferred routes, or a schedule of planned trips, possibly for use in commercial trips, including both long distance trips and short delivery routes. The DPTRS system then uses the user input to categorize the travel plan into one of multiple categories. FIG. 1 specifically identifies the following three nonlimiting categories: short trips, such as a commute or an errand; combination trips, such as a combination of short trips, for example, as would be the case with a delivery route; or long trips. In certain embodiments of the invention, a “short trip” might be defined as being under 30 minutes or under 60 miles, a “long trip” might be defined as any travel that is longer in duration or distance than a “short trip,” and a “combination trip” might be defined as six to thirty-five trips in a eight to ten hour period. As represented in FIGS. 11, 12 and 13, these categories can be used to assist the DPTRS system in determining what relevant data needs to be accessed. In addition, the categories can aid in a revenue model to accompany the route planning system, described below in reference to FIGS. 9 and 10. Finally, the TFI subsystem provides route recommendations to the user, as described in more detail in reference to FIG. 15.

As will be discussed in more detail with reference to FIG. 16, when forecasting traffic conditions, the TFI subsystem may take into account historical information, for example, traffic patterns such as known traffic bottleneck areas, and can further take into account other historical information relating to traffic patterns due to periodic events, for example, holiday, weekend, and recurring congestion patterns on highways as well as connected roads, and due to specific events, for example, special local events, visibility, precipitation, construction, and accidents on highways as well as connected roads. The TFI subsystem preferably provides route recommendations in real time and begins operation when the user inputs trip data. The trip data can include as little as the destination but, as discussed in more detail below in reference to FIG. 15, can also include planned breaks for food, rest, and gas and divide the trip into segments based on hours driven, specific stop locations, a start location different from the user's current location, or preset conditions such as commutes or day-to-day destinations. The TFI subsystem then identifies major map routing segments and determines optimal speeds and traffic flows for these segments. The TFI subsystem analyzes these segments using the aforementioned parameters to forecast potential traffic conditions and delays, then calculates one or more suggested routes to the user. In addition, the TFI subsystem continues to update and analyze the segments en route and generate feasible alternative routes (FIG. 2), providing the user with updated (real-time) route recommendations throughout the trip, as well as monitoring the user's route progress and providing information such as travel time remaining, fuel mileage, possible rest stops, and upcoming traffic, roadway, and weather-related conditions or delays.

The local sense mentioned previously, and cited several times in the following description of system processes, is a feature integral to certain advantages the DPTRS system may provide in trip planning. Local sense, as it is defined herein, is the expertise and knowledge developed by an above-average skilled commuter and long-time local resident of alternative feeder roads and highways within a local through which a recommended route will pass, and traffic congestions and slowdowns at different times of day on these roads. Local sense, as it is employed in this system, includes knowledge of a diverse set of information. This knowledge includes, but not limited to: local roadways that get bottlenecks at certain times of day; auxiliary roadways around traffic choke points; smaller roads parallel to highways or expressways; knowledge of toll ways such as tag-only required exits, exact change, human attendants, and costs; school zones; school bus routes and stopping points; railroad crossings; road and highway attributes such as business or commuter lanes, exit only lanes, tollways, traffic lights, roundabouts, and stop signs; knowledge of dangerous or difficult intersections; difficult or uncomfortable left turns due to traffic; knowledge of red light camera intersections; toll way on-ramps and off-ramps to avoid for optimal cost-effective savings, knowledge of traffic sense to minimize sudden lane changing in anticipation of highway exits; knowledge of weather-dependent roadway attributes such as roadways prone to flooding, roadways with steep gradients or dangerously curvy routes, or roadways that are exposed to crosswinds or adverse weather; and roadways that are congested after major events such as those connected to stadiums or theme parks. Local sense, therefore, requires an expansive and diverse set of data, and the aforementioned information, as well as additional subjects not mentioned, contribute to local sense providing a comprehensive and helpful addition to the trip routing system.

During major traffic impacting weather events such as snow, ice, hail, thunderstorms, tornadoes, and hurricane activities, local departments of public works (or other similarly-authorized government entities) often dissemination information on roadway conditions, evacuation routes, and also additional local sense information from real-time snow removal activities. The DPTRS system is preferably adapted to integrate current real-time roadway conditions, streets that are being plowed in real-time, roads and lanes that have been plowed in the past few hours, advised speeds, etc. The routing system preferably selects that routes to include roadways that are prioritized to be plowed first in the hierarchy of major thoroughfares, and roadways having lanes reported as plowed and treated with deicing chemicals.

FIGS. 11, 12 and 13 will be discussed next, as they provide an overview of the operation of the TFI when employed on short, combination, and long trips.

FIG. 11 is a block diagram depicting the implementation of a short (e.g., commuter) trip in the DPTRS system with the use of a GPS-equipped device or application. Various types of electronic devices (hereinafter, “user devices” or “user device”) can be used for this purpose, including but not limited to mobile (portable) devices including such internet-connected mobile devices as conventional smartphones, laptops, tablets, etc., as well as internet-connected browsers on personal computers and devices built specifically for use with the DPTRS system. Such specialized user devices, referred to herein as “system-dedicated devices,” must be GPS enabled so that the DPTRS system can measure the progress of the user. Throughout the trip, the DPTRS system uses location data from the user device to update route progress, forecasts, and recommendations. The user device may be equipped with navigational software necessary to provide the DPTRS system with the positional information it needs and to receive information as it is sent by the TFI subsystem such as route recommendations and travel condition updates. The navigational software is preferably functional and user-friendly, as determined by designers and the needs of the users. Icons, abbreviations, lists, and menus, well known to those skilled in handheld application design and easily recognized by the users of such applications, may be employed in this regard.

The user utilizes the user device to input their “Travel Plans” into the DPTRS system 11002, from which the system classifies the trip as a short trip (commuter) trip 11004. The user will have an opportunity to log into the system 11006, at which point the user may access various personal static data saved by the system in a user's static data preferences database 11046. This database contains frequently searched or visited destinations, favorite destinations, user interface, and other preferences, and additional user account information such as account payment balances and the subscription type for the user 11044. Such static data may include but are not limited to historical destinations or favorites. The user will then be able to input specific trip specifications 11008 with such details such as time started pulled from, for example, a GPS system clock, and ending address 11010. While the user is inputting the destination (11002), the navigational system may check one or more dynamic information databases 11012 (stored in the DTRM subsystem) to retrieve dynamic information across the area, which may include but is not limited to traffic accidents and traffic incidences, crime by zip code or neighborhoods, current weather patterns, watches and warnings, current traffic data, and local passenger and freight railroad patterns. After the system has retrieved the dynamic information, the current area situation is processed to see the impact of these various incidences on main, feeder, and arterial or ancillary roads 11016 along route recommendations 11018. Once a route is selected and started 11026, the local sense of the local bottlenecks 11022 is also integrated to see the dynamic information's specific impacts to the roads and the likelihood of creating area bottlenecks only known to locals and their affect on arterial and ancillary roads. When the user begins their trip 11020, the user device preferably displays the vehicle progress 11024 on a navigational map interface while also displaying dynamic information as it changes (11014) in various layers upon the map interface. While the navigational route is being used by the user, the system preferably continuously monitors dynamic changes that can happen upon the route and surrounding areas that may affect the navigational route 11036. If, for instance, a traffic incident, accident or backup occurs 11030, the system may check historical patterns 11034 and make necessary route changes based upon both the current traffic patterns 11030 and historical patterns 11034. Similarly, larger impact dynamic changes such as construction projects or weather patterns 11032 may also be used to dynamically monitor and make route changes or suggestions 11038 based on local bottlenecks and suggested detours during these situations. When the trip is complete 11040, trip data may be stored for future use as traffic and navigational statistics and to help to define additional historical patterns into the Master Database of Travel 11042, including speeds, traffic times, and traffic volumes upon the roadways, based upon crowd-sourced data input by users using their user devices and/or data collected by the Master Database 11042 from the user devices. Such trip data may be initially stored on user devices, which then transmit the trip data to the Master Database. Additional aspects of the DPTRS system as utilized for short trips can be discerned and appreciated from FIG. 11.

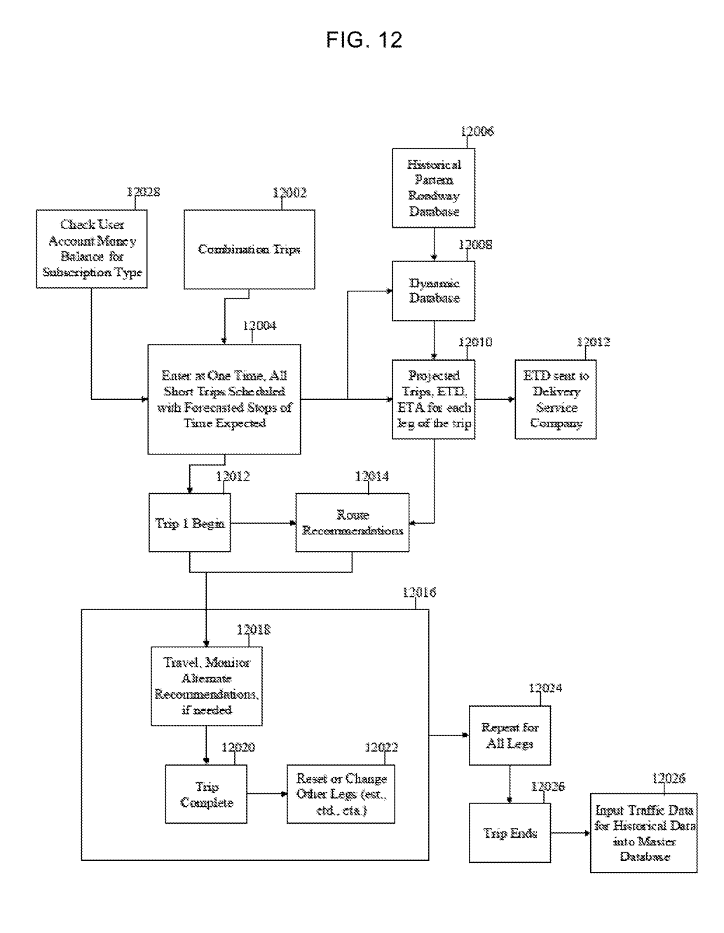

FIG. 12 shows representative DPTRS system processes capable of providing route planning for a combination of short trips (“combination trips”) 12002, such as of the type that might occur on a delivery route. Core processes are the same as those for a short trip (FIG. 11), including processes for checking account balance and subscription type for the user before starting the trip 12028. In FIG. 12, the user initially enters cargo source, origin or home base and identifies all projected trips and information related thereto (12004), including destination addresses. The system may then pull historical patterns from a roadway database 12006 within the geographical area of each destination and retrieve information from a dynamic information database 12008 (stored in the DTRM subsystem). Based on the dynamic information as well as the historical patterns, the system can determine an optimized route 12014 for deliveries to avoid known choke points while optimizing deliveries. The system may also project for each leg of the trip the estimated time of delivery and arrival (ETD, ETA) for the various legs of the trip (12010) and can relay this information to the delivery service company (12012) to provide additional data to the recipient of the deliveries, including an estimated time of delivery. Once the first leg (Trip 1) in the route has begun, the user device preferably displays the vehicle progress on a navigational map interface, and the system preferably continuously monitors any new dynamic information that relates to any given route and provide any new suggestions for deliveries 12018. As each leg changes, the system can notify the delivery service company when that leg is complete 12020 which can also be used for fleet management and will allow the user to change other legs depending on new data that is dynamically changing 12022. This system will preferably continue monitoring and making route changes for each leg 12024 inputted by the user until the complete trip ends 12026. Once the trip has ended, trip data may be stored in the Master Database (of travel) 12028 for future use as traffic and navigational statistics and to help to define additional historical patterns, including speeds, traffic times, and traffic volumes upon the roadways based upon crowd-sourced data input by users using their user devices, and/or data collected by the Master Database 12028 from the user devices. Additional aspects of the DPTRS system as utilized for combination trips can be discerned and appreciated from FIG. 12.

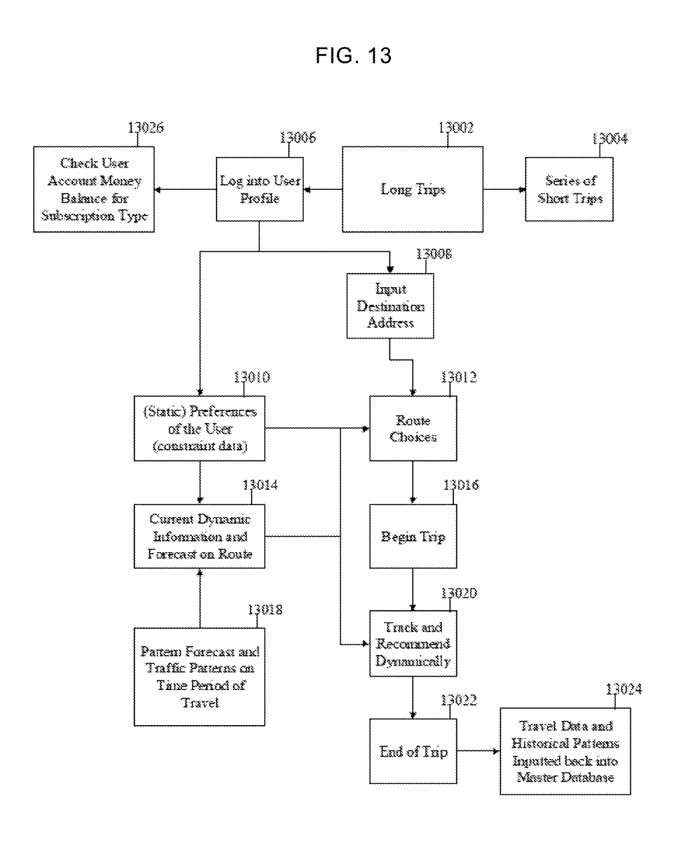

FIG. 13 shows representative DPTRS system processes capable of providing route planning for “long trips.” Again, core processes are the same as those for short trips (FIG. 11) and combination trips (FIG. 12), including processes for checking account balance and subscription type for the user before starting each trip 13026. However, the scope of information may be greater. The user inputs his/her travel plans into the DPTRS system, for example, as a long trip 13002 or a series of shorter trips 13004. The user is then able to log into his/her specific user profile 13006 and input his/her destination 13008 while the system also retrieves static user preferences 13010. The navigational system then retrieves current dynamic information 13014 (from the DTRM subsystem) in the areas of interest along the navigational route, as well as associated historical traffic patterns and traffic pattern forecasts for the predicted time period of travel 13018, and such information is taken into consideration when the system offers route choices from which the user makes his/her route choice 13012. Once the user has selected a route and has begun his/her travel (13016), the user device preferably displays the vehicle progress on a navigational map interface, and the system preferably continuously monitors any new dynamic information that relates to the navigational route and notifies the user of any impending decisions based upon his/her static user preferences (13020). Once the trip has ended 13022, trip data may be stored in the Master Database (of travel) 13024 for future use as traffic and navigational statistics and to help to define additional historical patterns, including speeds, traffic times, and traffic volumes upon the roadways based upon crowd-sourced data input by users using their user devices, and/or data collected by the Master Database 13024 from the user devices. Additional aspects of the DPTRS system as utilized for long trips can be discerned and appreciated from FIG. 13. This system may check major travel warnings or advisories issued by local, state, and federal government agencies for travel on affected highways in that region due to adverse or dangerous conditions, including adverse weather and hazardous materials spills, and recommend alternative routes and suggestions to complete the intended trip. The system can additionally route or give halting suggestions to avoid known peak metropolitan area traffic to ensure user safety.

It should be noted that at any time, for any category of trip, the user may change trip settings and preferences, including the destination, and the DPTRS system will preferably provide accommodating recommendations.

FIG. 14 illustrates a level of detail which the user profile 14002 (e.g., corresponding to the user profile 13006 in FIG. 13) used by the TFI subsystem may provide for use in any of the three scenarios of FIGS. 11 through 13. It should be noted that these preferences may be compiled as a result of the system automatically collecting user historical trends (11042, 12026, 13024), or as a direct input from the user. Additionally, user profile data may be categorized into trip types 14034, such as business (commute, delivery) 14036, vacation 14038, or leisure travel 14040. After this selection has been made, additional profile information can be inputted into the TFI subsystem, nonlimiting examples of which include preferred time periods of travel 14004, specific hours or miles to be covered in a day, specific destinations or via points to be reached, preferred types of routes (interstates, toll ways, etc.) 14006, number and frequency of breaks (including gas and food breaks) 14012, anticipated with preferred halt times, types of weather to avoid 14042, for example, tornado activity, black ice, fog, snow storms, ice, freezing rain, severe winds, hail storms, hurricane and tropical storm disturbances. Weather related information may include specific information about roadway conditions 14044 the driver wants to avoid, such as but not limited to nighttime driving (data based upon static data from NOAA Weather Service's sunrise and sunset hours), freezing temperatures, foggy conditions, or various precipitation conditions like snow or rain. All such information may form part of the relevant data used by the DPTRS system.

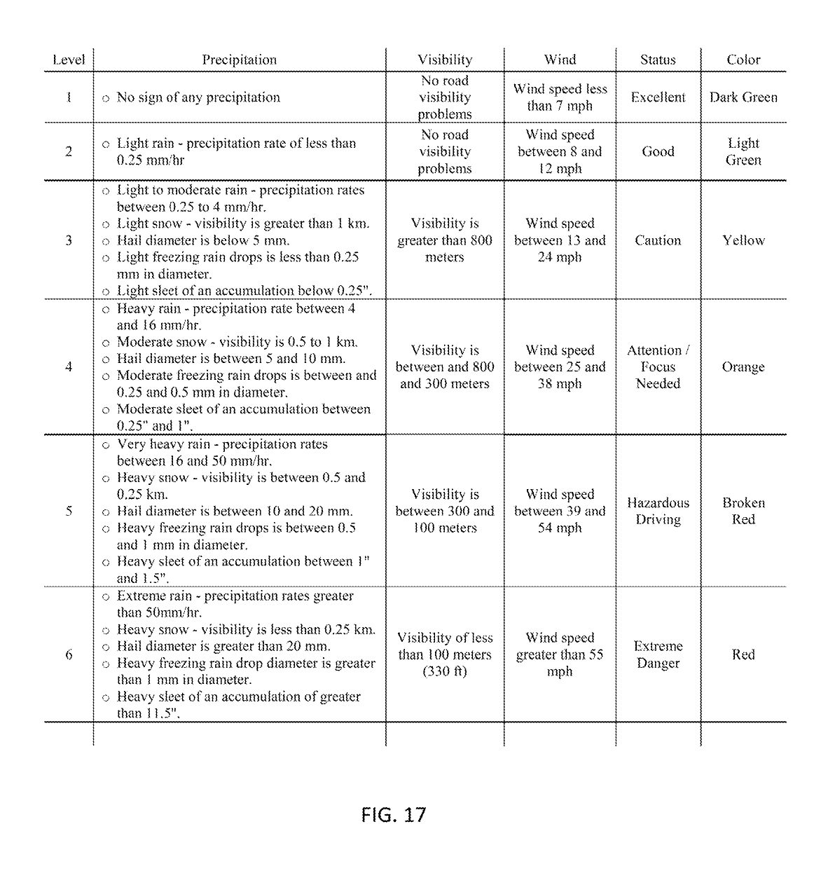

In one particular embodiment of the invention, the intensity of the weather conditions is displayed to the user using a simple aggregated and color-coded system to present the effect of current driving conditions, forecasted changes in these conditions, and potential challenges for safe driving based on intensity levels of weather conditions. This index, herein referred to as the Driving Conditions Tracker (DCT), takes three factors into consideration: visibility; weather precipitation; and wind conditions. In one embodiment, the DCT uses a scale of six colors to represent change in overall weather conditions, from dark green to red. Green may represent perfect or near-perfect driving conditions, while red may indicate severe weather. FIG. 17 illustrates how changes in intensity in these three factors can correlate to a change in the DCT. The DCT is intended to be used quickly and conveniently. For particularly long trips, the DCT may divide the trip into segments to indicate sections of the trip with distinctively different weather conditions. The conditions shown in FIG. 17 are relative, and the correlation of conditions to color index may change due to a variety of configurations. For example, the DCT may be used as an index standard to all users of the system. It may also be configured to certain vehicle types, as well as user preference. The DCT is intended to be an additional function of the overall system, and does not replace the more detailed services also provided by the system.

Other potential factors and inputs identified in FIG. 14 illustrate the breadth of information contained by a preferred embodiment of the user profile 14002. Some of these preferences and conditions may include items such as number of traffic lights on the road 14008, or avoidance of high crime level zip codes or neighborhoods 14010. The frequency of breaks required either by an employer or because of various passenger constraints such as pets, elderly, children and babies 14012 can bring additional relevant data into the system to suggest various stop locations during routing when approaching an allotted break or rest area. Interstate and roadway points of interest can be set as a favorite or other points of interest when the user has various constraints on their routing. Some points of interest can include: lodging 14016; food, beverage and rest stop locations 14018; fueling stations 14020 that may carry specific fuel types such as diesel, recharging stations, CNG, LNG, or specific brands of gasoline; museums, attractions, parks and other landmarks 14022; clean bathroom locations and preferences 14024; RV friendly areas 14026; Pet friendly areas 14028; public boat ramps 14030; and various dealerships and other vehicle repair locations 14032. The trip specific details 14034 can be set into the profile of the user such as business 14036, vacation 14038, or leisure or scenic trips 14040. A business trip profile setting can allow settings such as specific hours or miles to cover in a trip, number of gas or food breaks anticipated with the preferred timings of those breaks, typical average miles per hour targeted for this trip and preferred ETA at the destination. Vacation and leisure or scenic trip settings can allow settings such as preferred ETA at the destination, number of gas or food breaks anticipated with preferred timings for those breaks, and suggestions for various points of interests along the way depending on the user. The routing system can anticipate weather 14042 and roadway conditions 14044 intersecting a planned route, and can provide alternative before the adverse conditions are encountered. Additionally, major construction project and construction project detours 14046 can be used in the profile to be set as avoidances for the user. Other considerations that can be included in the user profile 14002 include gas price thresholds, lodging rating or price thresholds, and toll way rates, types, and features including bridges, turnpikes, tunnels, entries, etc. The system may utilize toll way rates and entry points to give a user the option to reduce toll fees by entering a toll way at later entry points.

FIG. 15 illustrates a level of detail by which any or all inputs identified in FIG. 14 can create User Inputted Information 15004, which may then be used by the DPTRS system in a trip planning scenario, for example, those of FIGS. 11 through 13. The system may also check for the subscription type associated with the account and the associated account money balance for the trip charge 15038. Based on such criteria, after the user chooses a trip plan 15002 (e.g., destinations for a short, combination, or long trip), the navigational system creates various trip route options (1 through N) 15006 from which the user can select a particular route 15008. Preferably, the DPTRS system displays ranked (“top”) choices to the user, depending on the user's criteria (the profile's static personal preference data) 15010. For example, multiple route suggestions can be ranked according to a system appraisal performed for the user based on the user's profile, and/or according to time, deviation from the specified user trip, or points of interest designated by the user. The system also displays any additional static relevant data information along the route choices, as nonlimiting examples, any known road construction or closure projects along the routes 15012. Once a route has been selected, the TFI subsystem may verify, within a certain period of time before departure 15014, any additional road construction projects on the selected route that can be identified from, but not limited to, the Department of Transportation's Federal Highway Administration's National Traffic and Road Closure Information and all states' Department of Transportation Web pages. As can be seen, the DPTRS system takes a wide variety of sources into account when providing a preferred route. This information is collected and maintained by the DTRM subsystem, as will be discussed in more detail below. It should be noted that FIG. 15 illustrates the breadth and detail that can be used to maintain such an exhaustive database, but that these factors are not limiting, and additional factors may be desired or necessary to provide a satisfactory result, subject to the views of the designers and administrators. In addition, it should be noted that these factors may not all need to be included if they are found to be superfluous to user needs or system capabilities.

FIG. 16 is a block diagram depicting a variety of sources of dynamic information that can be stored in a Dynamic Information Database 16002 within the DTRM subsystem (the Dynamic Information Database 16002 generally corresponds to the databases 11012, 12008, and 13014 of FIGS. 11 through 13). Some of the sources of dynamic information may include: current roadways conditions 16004 that is sourced from specific local metropolitan area traffic databases and news outlets, Department of Transportation databases, crowd-sourced databases, traffic cameras, and users using the DPTRS system and inputting current traffic data to the DTRM subsystem. The historical traffic patterns 16006 on roadways on or near a route are also included with the current roadway conditions 16004 for routing purposes. Traffic conditions including incidences and heavy traffic 16008 are retrieved from similar sources as those for current roadway conditions 16004 along with their associated historical traffic patterns and patterns on the arterial and ancillary roadways 16010. Specific knowledge provided by, for example, human consultants and relating to local traffic trends, referred to as local sense 16012, can draw upon current and historical trends of the roadway conditions 16014. Also included in FIG. 16 are major roadway construction projects and construction project detours 16016 that may occur on the navigational route with their associated historical traffic pattern prediction and effect on ancillary and arterial roadways 16018, and weather conditions including current and forecast weather disturbances 16020 as determined from the National Weather Service database and local news media weather center outlets to determine local weather patterns, severe weather watches and warnings. The historical traffic patterns seen on major roadways and associated ancillary and arterial roadways 16022 can also be retrieved into the Database 16002. Other incidences such as HAZMAT spills or other roadway incidences 16024 can be retrieved to the Database 16002. Furthermore, holiday travel and special event traffic 16026, including conventions, conferences, sporting events, concerts, and festivals, is retrieved and historical traffic patterns and patterns on the main, arterial and ancillary roadway affect 16028 can be input into the Database 16002.

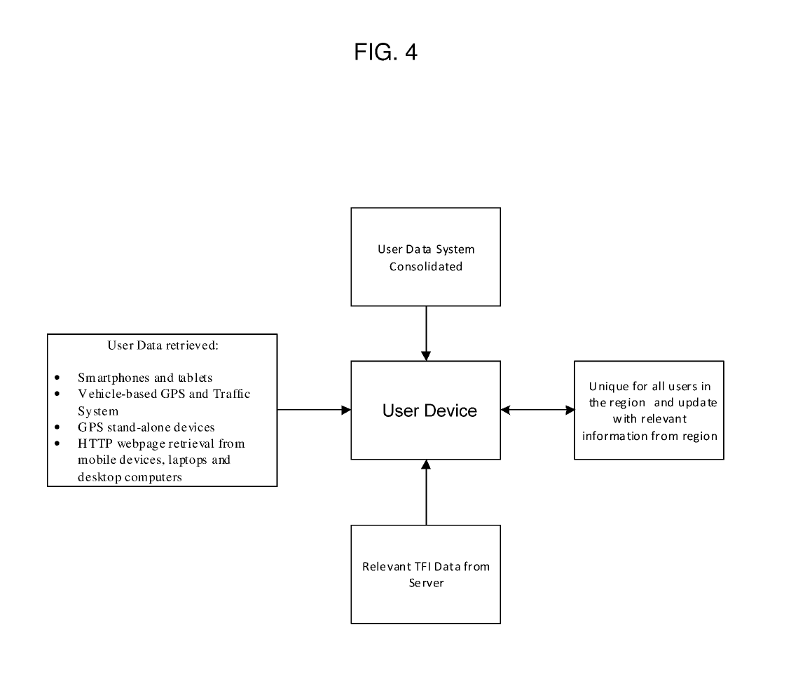

FIG. 4 illustrates a method of data collection for the TFI subsystem, including user-contributed data input into or collected by the subsystem through user devices. Data may also be collected from relevant data already on the DTRM subsystem servers.

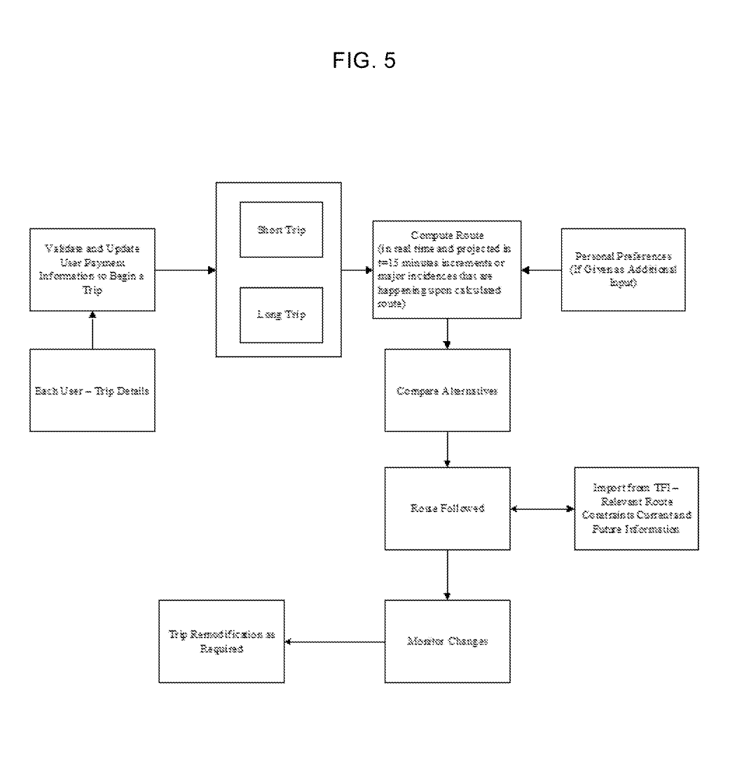

FIG. 5 is a flowchart showing steps that the TFI subsystem may use to operate, beginning with user initiation. The user is able to set trip specifications, after which the TFI subsystem computes the forecasted route conditions, compares alternative routes, and provides recommendations. As noted previously, the TFI subsystem preferably monitors changes in traffic, roadway, and weather conditions and, based on these real-time updates, provides modified alternatives as required while the user is en route on their trip.

The TFI subsystem may include a Traffic Flow and Speed Constraints and Resumption Times (TFSCRT) subsystem that can use known traffic models related to traffic density, duration, time of day, and speed change to provide detailed forecasts for road segments. Such a subsystem can be used to aid the TFI subsystem in providing realistic route data. In addition, the TFSCRT subsystem may include information from users in order to fine-tune forecasts for specific areas. The TFSCRT may take into account residential areas, traffic and population density, major road intersections, commercial and business centers, hospitals and other government areas, and other factors that contribute to traffic conditions.

The traffic conditions data analysis performed by the TFI and TFSCRT subsystems can be performed by the application of computer programs and analytic techniques belonging to a category of mathematics known in the art as computational fluid dynamics. The TFI subsystem may apply suitably modified variations of mathematical, scientific, and statistical flow models such as Continuum Flow Models and Simple Continuum Models in the form of a number of algorithms and traffic flow equations developed for application and employed at different junctures of the congestion flow modeling. Different types of traffic flow equations can be considered and applied to different congestion types such as Lighthill-Whitham-Richards (LWR) model, Aw-Rascle traffic flow model, Payne-Whitham model and generalizations thereof. The data analysis and congestion modeling provides real-time feedback to determine estimated time delay of the congestion, type of congestion for additional user information, and estimated delay for congestion to clear to determine alternative routing based on user preferences or giving routing suggestions for the user.

An example of a server architecture for the DTRM subsystem is represented in FIGS. 7 and 8. Along with the TFI subsystem, the DTRM subsystem (including its relevant data collection and storage function) is a major component of the DPTRS system. The TFI subsystem accesses the DTRM subsystem, which collects, maintains, and distributes information throughout the DPTRS system, including relevant data for DPTRS system users, but otherwise operates independent of the users. This information can include both current conditions and historical trend data such as bottleneck points and seasonal or event-related traffic. The TFI subsystem may update its map data and forecasts depending on the time of day and area population density, as indicated in FIG. 2, where “Region 1” may be classified as very large cities with metropolitan statistical areas having populations of greater than five million, “Region 2” cities may be classified as large cities with metropolitan statistical areas having populations between three and five million, and Region 3 cities are classified as medium US cities with metropolitan statistical areas having populations under three million. The map data and forecasts are preferably maintained for some amount of time, possibly six hours, though this could be increased depending on needs and capabilities. It should be noted that certain functions of the DTRM subsystem are believed to be critical to the function of the overall DPTRS system, and the successful use of the DPTRS system by the user, but that the platform used to perform this function may change depending on the needs and conditions of the administrators and users. Tools such as cloud-based hardware platforms, road and traffic databases, government administration servers, and crowd-sources databases may be used if it shown to preferable and advantageous.

The DTRM subsystem can process, display, and operate programs and files necessary to aid in navigation routing, for example, GPS programs and files. The DTRM subsystem may access a variety of sources to collect and maintain information on travel routes, points of interest, and local surroundings such as businesses or buildings. Simply put, the DTRM subsystem preferably maintains all information possibly related to or useful for a trip, from government emergencies to clean bathrooms. Servers utilized by the DTRM subsystem (e.g., “alpha” and “beta” in FIG. 7) are maintained by administrators, who ensure that the information collected by the DTRM subsystem is comprehensive and complete to ensure satisfactory function of the DPTRS system.

FIGS. 3 through 5 illustrate how the DTRM and TFI subsystems may interact. FIG. 3 shows that the source of relevant data for the TFI subsystem, which includes data contributed by the user as well as outside sources such as weather data providers, maintains the TFI subsystem. The TFI subsystem then sends its relevant data to the DTRM subsystem servers (“Servers 1-N”) which maintain this information. The DTRM subsystem servers are regional and categorized users as well as relevant data based on location.

Users can access the DPTRS system, including its TFI and DTRM subsystems, through their user devices. Users of the system preferably receive a map client from the DTRM subsystem to their user device, by which the user device is able to receive map data from an outside server. The map client provides the user with the map interface, which provides a visual representation of their route and possible alternatives. The zoom level for the map interface on a user device may be locked so as to limit the amount of data the user needs to download from the DTRM subsystem. In a possible embodiment of the invention, the user may establish preferred settings, such as frequent or preferred routes, driving duration, avoiding certain areas, or preferred stopping points.

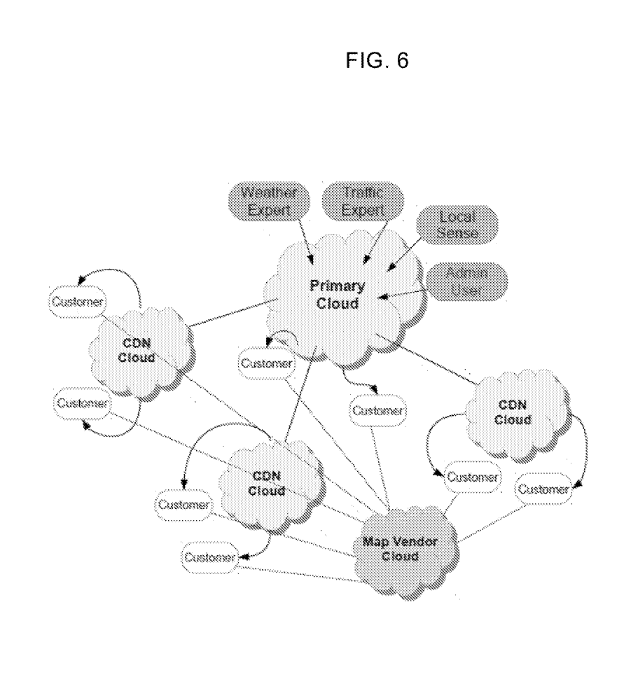

FIGS. 6 through 8 represent aspects of the DTRM subsystem for collecting and distributing relevant data for potentially several hundred thousand users of the DPTRS system. FIG. 6 represents a cloud data architecture for the DPTRS system as comprising a “Primary Cloud,” “Content Distribution Network” (CDN) clouds, and a “Map Vendor Cloud.” The Primary Cloud is part of a primary network that stores all relevant data utilized by the DPTRS system. With the CDN clouds, the Primary Cloud defines secondary networks which distribute information to users via the CDN clouds, which receive the information from the Primary Cloud. The Primary Cloud preferably receives and/or collects trip data directly from users, as well as receives and/or collects outside information from sources such as a traffic and weather information providers. The Map Vendor Cloud is an outside server through which the map client on a user device directly receives map data in coordination with the TFI subsystem and data supplied by the CDN clouds. The CDN clouds may be categorized geographically. FIG. 7 represents an exemplary server topology for servers in the DTRM subsystem.

Administrators of the DPTRS system are preferably able to access the Primary Cloud to manually input weather and traffic data, as well as manage data synchronization, billing, and other administrative aspects of the DPTRS system. These users would access the DPTRS system using modules specific to the operation, as illustrated in FIG. 8.

The DPTRS system incorporates sophisticated and complex algorithms, handles large volumes and varieties of data, complex pattern recognition, and prediction function, all in real time. As such, this system requires advanced knowledge of programming and information system capabilities and functions. The DPTRS includes several major types of processes to collect, analyze, decipher, and utilize the information, as well as provide forecasts. It includes pattern recognition processes to develop known and predictable patterns from historical traffic data for each road segment. Patterns may pertain to traffic volumes at different times of day, as well as visibility, precipitation, wind, and other weather-related conditions. The DPTRS also includes congestion modeling processes to develop and categorize congestions by attributes such as changes in speed, duration, or affected area. Another process integrates updated (real-time) traffic, weather and accident conditions or other events through pattern recognition processes and congestion modeling and applies probability functions to predict time of travel on many alternative routes. Finally, the DPTRS includes an identification and benchmarking system for detecting and analyzing differences between predicted value ranges, improving prediction accuracies by using these benchmarks to determine discrepancies between predicted travel times and recorded travel times, and using these differences to further improve accuracy.

To accomplish these tasks, a variety of algorithm methodology classes may be employed within the system architecture. These methodologies classes include Clustering Techniques and Analytics, Complex Multi-Dimensional Pattern Recognition Techniques, Dynamic Modeling and Programming, Simulation based Optimizations, Neural Networks and Machine Learning, and Likelihood Functions, as well as other related methodology classes not cited here. The system also employs Dynamic Data Driven Application Systems, which are built to incorporate data arriving in real time from heterogeneous sources while executing an application with given parameters or in modifying a prior solution for a new set of constraints. The system may also employ Multi Criteria Decision Analysis, as well as modeling tools related to the study of fluid dynamics to model congestion. These methodologies are well known to those skilled in the art.

An additional feature of the DPTRS system is the ability to gather and incorporate traffic data and use it in a way similar to an experienced and observant driver may learn the same traffic patterns over time. The DPTRS system can learn through trial and error to choose an optimal route for regular trips by observing and determining roads to avoid due to frequent emergency vehicles such as ambulances or police, traffic lights, busy intersections with irregular or delayed lights, and other irregular factors. In addition, the DPTRS system can incorporate expert information manually contributed by human consultants, ranging from traffic policeman, local traffic specialists, and government transportation employees to national, regional, and local national databases.

In summary, the DPTRS system may provide and update route recommendations to users in real time by taking into consideration one or more of updated traffic conditions, updated roadway conditions, updated weather conditions, user trip specifications, route data collected from other users, updated traffic patterns, and local and regional factors while a user is en route on their trip. The DPTRS system is designed to provide this feature and gather information from several hundred thousand users efficiently. The DPTRS system is designed to assist drivers while minimizing user interaction and possible distraction once the program is initiated. As a result of the dramatic improvements the DPTRS system provides for users, secondary benefits such as reduced time and financial expenses, as well as reduced stress, may be provided to the user as well.

A preferred but optional aspect of this invention is a revenue model to accompany the DPTRS system. The revenue model does not require advertiser support, but instead may use one or more of several payment methods represented in FIGS. 9 and 10. Users may Pay When Used (PWU), incurring a single charge for each trip. This charge preferably varies in relation to the length of a trip. Users may also subscribe to the service for some duration of time, possibly a month, with limits set on trip durations or frequency. Commercial routes such as delivery routes may also be subject to unique pricing, such as a charge per delivery route. Users may also be allowed to purchase unlimited usage for a specific amount of time. As and if needed, driver distraction minimization and activity monitoring features can be built into the navigational or communication user devices of types used by drivers in commercial vehicles. These features will likely reduce the commercial carrier's liability insurance premiums due to potential reduced legal liabilities.

Yet another preferred but optional aspect of this invention is a subsystem capable of providing user feedback to routes suggested by the system. This subsystem provides feedback to the DPTRS system beyond the actual route the user followed if it was different than the predetermined route or a rerouting suggested by the DPTRS system. After a user's trip/route has been completed, a feedback interface can be provided via the user's user device to enable the user to input a quantitative user rating for the route, for example, overall ratings for the entire route, partial ratings for individual segments of the route, or other aspects of the route. The feedback interface may further enable the user to transmit the user's rating to a remote system, and include a plurality of selectable graphical features to indicate higher or lower rating. The feedback subsystem may determine whether a user's rating is equal to or higher than a predetermined value, which the system may use to provide future selectable features or prompt the user for additional feedback, particularly if the user's rating is below the predetermined value or some other threshold value. If the feedback subsystem receives negative feedback for part of a navigational route, the subsystem may identify the corresponding characteristics of that route that had been unsatisfactory for the user. The system preferably uses the user feedback as additional input to identify and optimize routing for local sense information with specific segments of navigation that were optimal or suboptimal. The system may further identify which segments the user preferred and subsequently use those segments as preferred routing for specific users.

In another preferred but optional aspect of this invention, a receipt can be generated and provided to the user after the navigational route has been completed. For this purpose, the system may provide a service summary or receipt of the navigational routing, information including the cost for the service, type of journey, type of service performed, and the person who performed the service. The summary receipt or any part of its information can be displayed on a display of the user device or sent to the user via electronic receipt to the contact information associated with the user profile. The receipt can be displayed in combination with the feedback interface of the aforementioned feedback subsystem. The receipt preferably identifies the location for the service rendered, identifies date and time when the service was rendered, displays the navigational route the user followed, identifies the type of routing that has been conducted, and gives the option to the user to share the routing service on social media webpages.

While the invention has been described in terms of specific embodiments, it is apparent that other forms could be adopted by one skilled in the art. Accordingly, it should be understood that the invention is not limited to the specific embodiments illustrated in the Figures. It should also be understood that the phraseology and terminology employed above are for the purpose of disclosing the illustrated embodiments, and do not necessarily serve as limitations to the scope of the invention. Therefore, the scope of the invention is to be limited only by the following claims.

1. A dynamic personal travel routing system providing and updating route recommendations for a plurality of users, the system comprising:
means for creating and maintaining a user profile for each of the users;
means for collecting and maintaining relevant data in a database;
accessing means for the users to access the system to specify user trips;
means for computing, subject to the relevant data, at least one route having a predicted optimal route travel time for each of the user trips specified by the users;
means for updating the relevant data in real-time;
means for updating the system on progress of the specified user trip; and
means for recording trip data relating to the route.

2. A system according to claim 1, wherein the relevant data comprises at least one of weather conditions, traffic data dependent on time of day and events, construction information, known traffic patterns including accident patterns, congestion patterns, traffic density patterns and connected roads, commercial databases provided by search engines or business directories, and expert information manually contributed by human consultants.

3. A system according to claim 1, wherein the means for computing comprises means for capturing data from a plurality of sources.

4. A system according to claim 1, wherein the computing means continuously provides alternative routes to users based on at least updated traffic conditions, updated roadway conditions, and updated weather conditions while the users are en route on the user trips thereof

5. A system according to claim 1, wherein the accessing means comprise at least one chosen from the group consisting of mobile devices, internet-connected browsers on personal computers, and system-dedicated devices.

6. A system according to claim 1, wherein the accessing means is configured for the users to specify trip parameters chosen from the group consisting of food, rest, or gas stops, intervals based on time or distance traveled, or alternative start locations.

7. A system according to claim 1, wherein the system further comprises a visual map interface that receives map data from an outside source and provides route information to the users.

8. A system according to claim 1, wherein the computing means continually provides the users with alternative or preferred route recommendations as the users progress on the user trips thereof.

9. A system according to claim 1, wherein the accessing means records the trip data and sends the trip data to the system database.

10. A system according to claim 1, wherein the user profiles individually contain user preferences of the users.

11. A system according to claim 9, wherein the user preferences comprise at least one of the following: common destinations; required or preferred time of arrival; preferred travel routes; required or preferred types of roads; avoidance of certain types of roads; preferred toll or ferry cost; avoidance of tolls; required or preferred driving durations; required or preferred driving distances; required or preferred periodic rest intervals; preferences for time of day or day of week travel; user trip types such as business, vacation, leisure, or commute; preferred or anticipated gas or food stops or breaks; required or preferred locations for fuel, food, drink, restroom, lodging, or rest stops; points of interest; and meteorological phenomena avoidance.

12. A system according to claim 1, wherein the system provides the route as one of multiple route suggestions to the users, ranks the multiple route suggestions according to system appraisal for the user, and optionally ranks the multiple route suggestions according to time, deviation from the specified user trip, or points of interest designated by the user.

13. A system according to claim 1, wherein the system comprises means for displaying intensity of weather conditions to the user using an aggregated and color-coded system that presents the effect of current driving conditions, forecasted changes in the driving conditions, and potential challenges for safe driving based on intensity levels of weather conditions.

14. A server system for operating as the means for collecting and maintaining the relevant data for the system of claim 1, wherein the server system comprises:
a primary network which stores the relevant data;
secondary networks which channel data from the primary network to the users;
modules for administrators to access the server system, input traffic and weather information, and input administrative and financial changes; and
means for coordinating the user profiles with map data from an outside source.

15. A server system according to claim 14, wherein the primary and secondary networks are cloud data networks.

16. A server system according to claim 14, wherein the secondary networks are geographically categorized.

17. A revenue model used with the system of claim 1 and the server system of claim 14, the revenue model comprising at least one of:
user payment by subscription or by charge-by-usage;
user cost dependent on length of the specified user trip;
options for a commercial user who repeatedly uses the system to acquire the route for the specified user trip; and
means for the users to pay from a mobile device.

18. A dynamic personal traffic routing method for providing and updating route recommendations for a plurality of users, the method comprising:
creating and maintaining a user profile for each of the users;
collecting and maintaining relevant data in a database;
the users accessing the system to specify user trips;
computing, subject to the relevant data, at least one route having a predicted optimal route travel time for each of the user trips specified by the users;
updating the relevant data in real-time;
updating the system on progress of the specified user trip; and
recording trip data relating to the route.

19. A method according to claim 18, wherein the relevant data comprises at least one of weather conditions, traffic data dependent on time of day and events, construction information, known traffic patterns including accident patterns, congestion patterns, traffic density patterns, and connected roads, commercial databases provided by search engines or business directories, and expert information manually contributed by human consultants.

20. A method according to claim 18, wherein the system continuously provides alternative routes to users based on at least updated traffic conditions, updated roadway conditions, and updated weather conditions while the users are en route on the user trips thereof.

21. A method according to claim 18, wherein the users access the system through at least one of mobile devices, internet-connected browsers on personal computers, and system-dedicated devices.

22. A method according to claim 18, wherein the users specify trip parameters chosen from the group consisting of food, rest, or gas stops, intervals based on time or distance traveled, or alternative start locations.

23. A method according to claim 18, further comprising providing route information to the users with a visual map interface that receives map data from an outside source.

24. A method according to claim 18, wherein the system continually provides the users with alternative or preferred route recommendations as the users progress on the user trips thereof.

25. A method according to claim 18, wherein the users access the system through a device which records the trip data and sends the trip data to the system database.

26. A method according to claim 18, wherein the user profiles individually contain user preferences of the users.

27. A method according to claim 26, wherein the user preferences comprise at least one of the following: common destinations; required or preferred time of arrival; preferred travel routes; required or preferred types of roads; avoidance of certain types of roads; preferred toll or ferry cost; avoidance of tolls; required or preferred driving durations; required or preferred driving distances; required or preferred periodic rest intervals; preferences for time of day or day of week travel; user trip types such as business, vacation, leisure, or commute; preferred or anticipated gas or food stops or breaks; required or preferred locations for fuel, food, drink, restroom, lodging, or rest stops; points of interest; and meteorological phenomena avoidance.

28. A method according to claim 18, wherein the system provides the route as one of multiple route suggestions to the users, ranks the multiple route suggestions according to system appraisal for the user, and optionally ranks the multiple route suggestions according to time, deviation from the specified user trip, or points of interest designated by the user.

29. A method according to claim 18, the method further comprising displaying the intensity of weather conditions to the user using an aggregated and color-coded system that presents the effect of current driving conditions, forecasted changes in the driving conditions, and potential challenges for safe driving based on intensity levels of weather conditions.

30. A method for providing feedback for navigational routing performed by a navigational routing system, the method comprising:
providing on a feedback interface an overall or partial navigational route rating feature to receive quantitative user ratings from users of the navigational routing system;
receiving via the feedback interface a quantitative user rating from a user of the navigational routing system;
making a determination with the feedback interface that the quantitative user rating is equal to or higher than a predetermined value; and
in response to determining that the quantitative user rating is below the predetermined value, providing selectable features to the user and prompting the user for additional feedback via the feedback interface.

31. The method for providing a service summary or receipt on a computing device related to navigational routing, the method comprising:
determining information relating to a navigational routing service rendered for a user, the information including cost for the navigational routing service, type of service performed, and person who performed the service;
displaying at least a portion of the information on the computing device; and
displaying a feedback interface that enables the user to rate the navigational routing service received.
